(19) United States
(12) Patent Application Publication
(10) Pub. No.: US 2008/0163938 A1
(43) Pub. Date: Jul. 10, 2008

(54) Apparatus, system and method for water-conserving irrigation utilizing check-valve screens

(75) Inventor: Travis Komara, Fontana, CA (US)

Correspondence Address: RUDOLPH J. BUCHEL JR., LAW OFFICE OF, P. O. BOX 702526, DALLAS, TX, 75370-2526, US

(73) Assignee: Salco Products

(21) Appl. No.: 11/650,400

(22) Filed: Jan. 5, 2007

(51) Int. Cl. F16K 15/00; B05B 1/28; F17D 1/00; F17D 3/00

(52) U.S. Cl. 137/511; 239/104; 137/561 R; 137/12

(57) ABSTRACT

The invention is an apparatus, system, and method for water-conserving irrigation utilizing check-valve equipped devices. By implementing a filtering device, for example a screen, adapted to connect to a connector of an irrigation outlet nozzle of said irrigation system, and employing a valve within the screen designed to prevent a flow of fluid out of the connector when a fluid pressure into said valve is less than a threshold pressure, every outlet to an irrigation system may be sealed to preserve water and prevent overirrigation caused by low head drainage.

### BACKGROUND OF THE INVENTION

1. Technical Field of the Invention

This invention relates generally to an apparatus, system, and method for water-conserving irrigation utilizing check-valve equipped devices, and in particular, a apparatus, for example a screen or an emitter, outfitted with a check-valve that may be integrated at the various outlets of an irrigation system, to preserve water and prevent overirrigation caused by low head drainage.

2. Description of the Related Art

Traditionally, irrigation systems have developed various methods and apparatus that help conserve water. Some of these apparatus include controllers, timers and complex pressure-valves that control water flow from the sub-main to laterals. Furthermore special nozzles, such as emitters, that control the amount and manner in which water is dispensed throughout a landscape are also utilized to prevent overirrigation and unnecessary saturation of chemicals in the soil.

Naturally, landscapes may vary in elevation, even if just slightly, meaning that some irrigation outlet nozzles (nozzles) can be situated at higher or lower elevations than other nozzles. This creates the problem of low head drainage. When one nozzle is lower than other nozzles, any water left inside the irrigation system will naturally be pulled by gravity towards the lowest point on the landscape; a nozzle that is situated at a lower elevation relative to the other nozzles throughout the system, then becomes an outlet for any remaining water inside the pipelines. For example, water left in the lateral pipes, sub-main pipes, or anywhere on the irrigation system, will drain out the lower situated nozzle until an equilibrium is reached, or the entire water supply (that has been left in the pipes after shut-off occurs), is completely drained out; this water loss will then re-occur with the end of every cycle.

Overirrigation, due to poor water distribution resulting from low head drainage, wastes water, chemicals, and in some cases may lead to water pollution. In addition to the environmental issues raised by this waste of water, low head drainage may be costly as well, particularly with large irrigation systems.

Furthermore, water drainage concentrated in one location of a landscape is undesirable since over watering may lead to a marshy, muddy, or otherwise damaged area unsuitable for landscaping, growing vegetation, or making any improvements thereof.

In the past, check-valves have been used to prevent water loss and conserve water. However, these check-valves are somewhat complex apparatus that are expensive and not adaptable to the various types of irrigation systems that are practiced today. A check-valve built into an industrial sprinkler system in an agricultural setting for example, is not compatible with a drip irrigation system set in a residential landscape.

Thus, it is desirable to tackle the problem of low head drainage to prevent water waste and overirrigation, while creating more efficient and cost-effective irrigation systems.

Therefore, there is a need in the art for providing irrigation systems with the capability to properly retain the water left inside an irrigation system's pipelines; a need exists for an irrigation system that is more efficient, less costly, and responsive to the environment by conserving water and preventing damage to soil, and in particular, a system that prevents low head drainage. Lastly, and most importantly, there is a need for an irrigation apparatus that is easily adaptable to any kind of irrigation system. These irrigation apparatuses also need to be easily installed in existing irrigation systems allowing it to retrofit any irrigation into a water-conserving irrigation system. It is to these ends that the present invention has been developed.

### SUMMARY OF THE INVENTION

To minimize the limitations found in the prior art, and to minimize other limitations that will be apparent upon the reading of the specification, the present invention provides a system and method for water-conserving irrigation utilizing check-valve equipped emitters.

An apparatus for conserving water in an irrigation system, in accordance with the present invention, comprises a filtering device adapted to connect to a connector of an irrigation outlet nozzle of said irrigation system, and a valve within said filtering device to prevent a flow of fluid out of said connector when a fluid pressure into said valve is less than a threshold pressure.

Another apparatus for conserving water in an irrigation system in accordance with the present invention comprises a low volume irrigation outlet nozzle, and a valve within said low volume irrigation outlet nozzle to prevent a flow of fluid out of said low volume irrigation outlet nozzle when a fluid pressure into said valve is less than a threshold pressure.

An irrigation system for conserving water in accordance with the present invention, comprises an irrigation fluid source, a plurality of irrigation outlet nozzles, and irrigation pipes to route a fluid from said irrigation fluid source to said plurality of irrigation outlet nozzles; wherein each irrigation outlet nozzle comprises a filtering device adapted to connect to a connector of each irrigation outlet nozzle of said irrigation system, and a valve within said filtering device to prevent a flow of fluid out of said connector when a fluid pressure into said valve is less than a threshold pressure.

A method of conserving water in an irrigation system, in accordance with the present invention, comprises installing a valve into a filtering device, connecting said filtering device to a connector of said irrigation system, turning on a fluid pressure to allow a fluid to flow to said irrigation system, turning off said fluid pressure, and preventing a flow of fluid out of said connector when said fluid pressure into said valve is less than a threshold pressure using said valve.

Another method of conserving water in an irrigation system, in accordance with the present invention, comprises installing a valve to a low volume irrigation outlet nozzle, turning on a fluid pressure to allow a fluid to flow to an irrigation system, turning off said fluid pressure, and preventing a flow of fluid out of said low volume irrigation outlet nozzle when said fluid pressure into said valve is less than a threshold pressure using said valve.

It is an objective of the present invention to create an irrigation system that may be sealed to prevent low head drainage.

It is another objective of the invention to achieve such water conservation through an apparatus that is easily adaptable into any irrigation system.

It is yet another objective of the present invention to add efficiency to irrigation systems.

It is still another object of the present invention to make irrigation systems more cost effective.

It is still another objective of the present invention to retain water within an irrigation system between cycles of operation.

It is still another objective of the present invention to prevent over irrigation that may cause damage or is otherwise undesirable.

It is still another objective of the present invention to conserve water in irrigation systems.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a diagram of a typical irrigation system in accordance with the present invention.

FIG. 2 is an illustration of an irrigation system installed on an uneven landscape, equipped with low head drainage-preventing emitters in accordance with an exemplary embodiment of the present invention.

FIG. 3 is an illustration depicting a close-up look at an irrigation system showing some of its components and a variety of locations for implementing a sealing apparatus in accordance with various embodiments of the present invention.

FIG. 4 is an illustration depicting a cross-sectional view of a check-valve equipped emitter used to prevent low head drainage, in accordance with an exemplary embodiment of the present invention.

FIG. 5(a)-FIG. 5(c) illustrate emitter 400 in three distinct stages of operation, in accordance with an exemplary embodiment of the present invention.

FIG. 6(a) and FIG. 6(b) are illustrations depicting three major components of a screen outfitted with a check-valve to prevent low head drainage upon a decrease of fluid pressure within an irrigation system, according to an exemplary embodiment of the present invention.

FIG. 7(a) and FIG. 7(b) are different views of one component of screen 600, in accordance with an exemplary embodiment of the present invention.

FIG. 8(a)-FIG. 7(d) are different views of another component of screen 600, in accordance with an exemplary embodiment of the present invention.

FIG. 8(a) and FIG. 9(b) are different views of yet another component of screen 600, in accordance with an exemplary embodiment of the present invention.

FIG. 10(a) and FIG. 10(b) are cross-sectional views of an assembled screen 600, in accordance with an exemplary embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the invention.

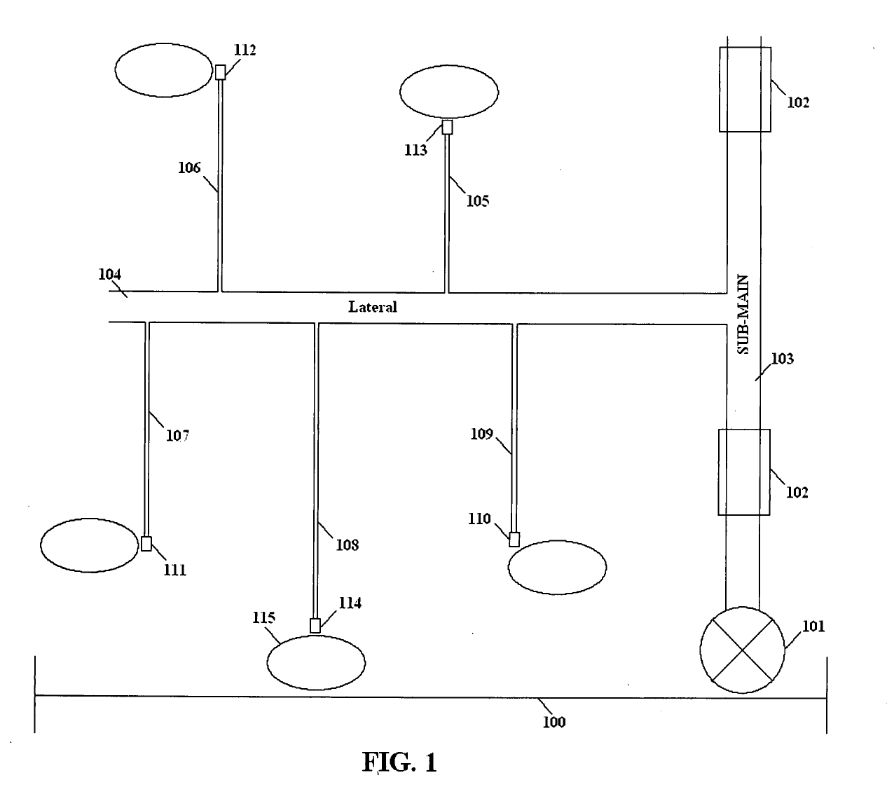

Turning first to FIG. 1, a diagram of a typical irrigation is shown as a way to explain the layout and illustrate the useful nature of an irrigation system in accordance with the present invention. Irrigation system 100 comprises of controller 101, main valves 102, sub-main 103, lateral 104, raisers 105-109, emitters 110-114, and various targets, or locations where irrigation is desired, such as target 115. The various components of irrigation system 100 and their interrelationships are discussed in turn.

Controller 101 may be any type of controller known in the art capable of running an irrigation system. Typically, controller 101 is an automatic timer used to control irrigation system 100. Controller 101 may be as complex as a sophisticated computer or may be as simple as a manual on and off switch, without departing from the scope of the present invention.

In one embodiment, controller 101 is capable of multiple functions such as setting the frequency of irrigation, the start time of each cycle, and the duration of watering for irrigation system 100.

In another embodiment, controller 101 may be very sophisticated, equipped with multiple programs to allow different watering frequencies for different types of plants or rain delay settings.

Main valves 102 are used to control the flow of water throughout irrigation system 100. Main valves 102 may be used to shut-off water for repairs to sub-main 103 or lateral 104, turn on and off the water to the individual circuits of nozzles throughout irrigation system 100 (i.e. including nozzles 110, 11, 112, 113, and 114), or allow the water to flow in only one direction. Typically, in addition to main valves 102, a master valve located at the water source turns on and off the water for the entire irrigation system when not in use.

Sub-main 103 is typically a larger pipe that distributes water to smaller pipes such as lateral 104, which in turn distributes water to the various raisers 105, 106, 107, 108, and 109. Sub-main 103 may be constructed of metal, plastic, or any other material known in the art suitable for use with irrigation systems.

In one embodiment sub-main 103 and lateral 104 are manufactured from poly-vinyl-chloride (PVC) while raisers 105, 106, 107, 108, and 109 are made of a very flexible plastic such as polyethylene. As mentioned above, sub-main 103 and lateral 104 may be constructed of any material known in the art without departing from the scope of the present invention.

Nozzles 110, 111, 112, 113, and 114 are the various outlets of irrigation system 100, where water gets distributed to the various targets. Nozzles 110, 111, 112, 113, and 114 may be any type of nozzle known in the art. For example, nozzles 110-114 may be emitters, sprinklers, or simple outlets to allow the flow of water into the soil or targeted plants such as target 115, without departing from the scope of the present invention.

In an exemplary embodiment, irrigation system 100 is a drip irrigation system, and nozzles 110-114 are emitters that control the flow of water going to the soil at the various targets (i.e. target 115). However, irrigation system 100 can also be a sprinkler system without departing from the scope of the present invention.

Target 115 illustrates one of many targets throughout irrigation system 100. Target 115 may comprise of any type of plant, shrub, or vegetation that irrigation system 100 may be set up to irrigate without departing from the scope of the present invention.

As way of illustration, and without limiting the scope of the present invention, irrigation system 100 may be set up to water a field of vegetables on a large farm. When controller 101 releases water into irrigation system 100, controller 101 opens main valves 102 allowing water through sub-main 103 and into one of many laterals, such as lateral 104. Water then gets distributed throughout raisers 105-109, where water is taken from lateral 104 to the individual targets, for example target 115. Nozzles 110-114 are connected to the end of each of the raisers 105-109 and dispense water to the various vegetables being grown at each target, for example, target 115 may contain a small tomato vine irrigated via nozzle 115.

Once a cycle of irrigation is completed, irrigation system 100 is automatically turned off by controller 101. Controller 101 will usually shut off main valves 102 to prevent any water from being distributed to the various targets or prevent any water from going back to the water source. At this point, irrigation system 100 stops the watering process, and no more water is continued to be pumped through sub-main 103 or lateral 104 into the various raisers 105-109.

Nevertheless, water that did not exit the system (and was not distributed or dispensed amongst the various targets) remains inside the various raisers 105-109, lateral 104, and inside part of sub-main 103. Naturally, the trapped water will travel to the lowest point on the system and drain slowly through the nozzle located at the lowest elevation. By implementing an apparatus that can be easily adapted to seal each individual nozzle, water can be contained and conserved when irrigation system 100 is shut off after a cycle of irrigation—otherwise the remaining water may end up dispensed all at a single target due to low head drainage.

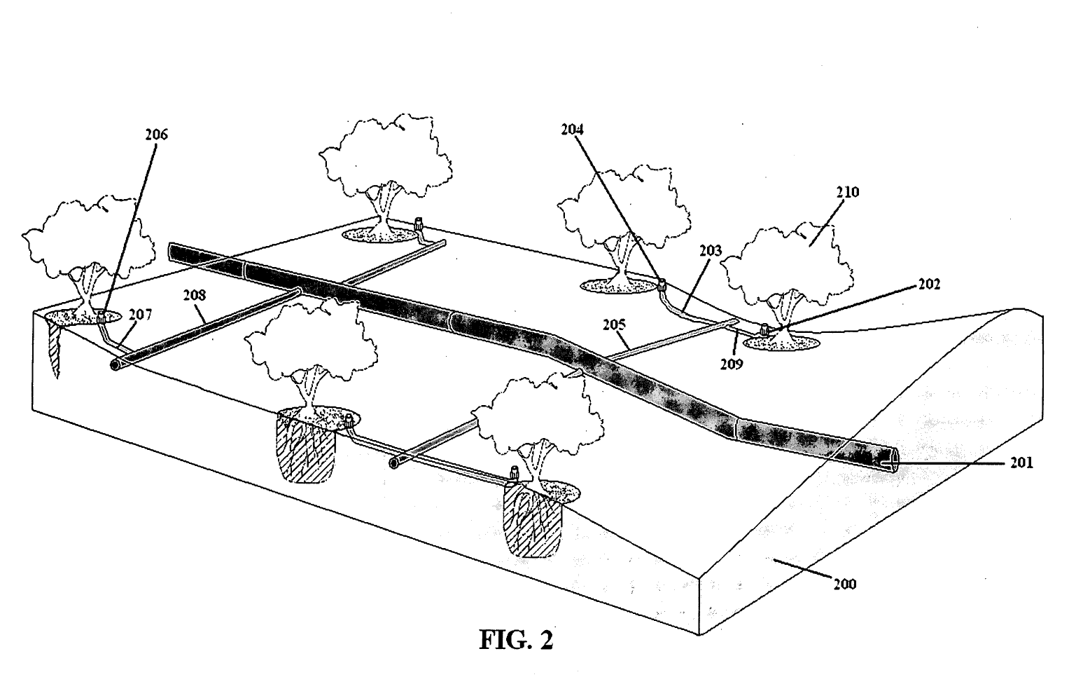

Now turning to the next figure, FIG. 2 is an illustration of a drip irrigation system, situated on an uneven landscape, which has been equipped with low head drainage-preventing apparatuses in accordance with an exemplary embodiment of the present invention. The illustration depicts a cross-sectional view of landscape 200.

Landscape 200 is equipped with an irrigation system that comprises of sub-main 201 which distributes water throughout its various laterals including lateral 205 and lateral 208. Each lateral is connected in turn to various raisers, each raiser leading to a single nozzle, and each nozzle leading to a single shrub.

FIG. 2 shows a number of shrubs irrigated in landscape 200, with shrub 210 being the lowest elevated plant on the illustrated section of landscape 200. Because emitter 202 is lower than emitters 204 and 206, all the water that remains in raiser 203, raiser 209, raiser 207, lateral 205, lateral 208, sub-main 201, or any other component of the irrigation system that rests higher than emitter 202, will naturally travel towards emitter 202 upon a decrease in fluid pressure that occurs when sub-main 201 stops distributing water at the end of an irrigation cycle.

Emitters 206, 204, 202 and all emitters on the irrigation system may be sealed upon a drop of fluid pressure, for example, every time an irrigation cycle ends and controller 101 shuts off the water supply.

For example, and without limiting the scope of the present invention, once the water supply to sub-main 201 is cut off, an apparatus in emitters 206, 204, and 202 will seal each emitter to prevent water from flowing out of the irrigation system. Any water that does remain in raiser 207 will naturally travel towards emitter 202. Similarly, any water remaining in raiser 203 or any other part of sub-main 201 will do the same. The lack of fluid pressure to overcome a threshold pressure within the apparatus will maintain each emitter sealed, thus conserving all the water that remains in the various pipes throughout the irrigation system.

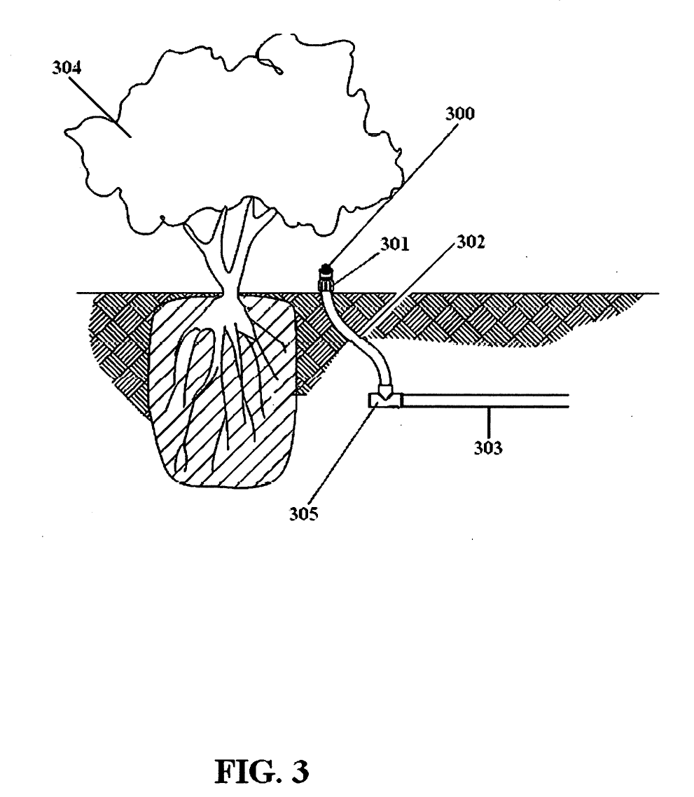

Turning now to the next figure of the drawing, FIG. 3 is an illustration depicting a close-up look at an irrigation system showing some of its components and a variety of locations for implementing a sealing apparatus in accordance with various embodiments of the present invention.

An irrigation system may implement a sealing apparatus on various locations throughout the irrigation system without departing from the scope of the present invention (see FIG. 3). Naturally, it is desirable to seal each outlet to irrigation system 100 by implementing a sealing apparatus as close to an outlet as possible—otherwise there is always room for water to accumulate during a cycle and be drained upon terminating irrigation.

In one embodiment, a sealing apparatus in accordance with the present invention is installed by opening emitter cap 300 and placing a sealing apparatus inside emitter 301. In another embodiment, a sealing apparatus may be installed anywhere on riser 302. In yet another embodiment, a sealing apparatus may be installed inside fitting 305. And in another embodiment, a sealing apparatus in accordance with the present invention, may be installed at the end of lateral 303. Consequently, sealing apparatus can be installed at any connector within said irrigation system without departing from the scope of the present invention. Installing a sealing apparatus far from the outlet may not be desirable since water that is left between an outlet, for example emitter 301, and a sealing apparatus, may still be wasted.

In an exemplary embodiment, a sealing apparatus in accordance with the present invention, is implemented in every outlet or nozzle of an irrigation system, for example inside emitter 301.

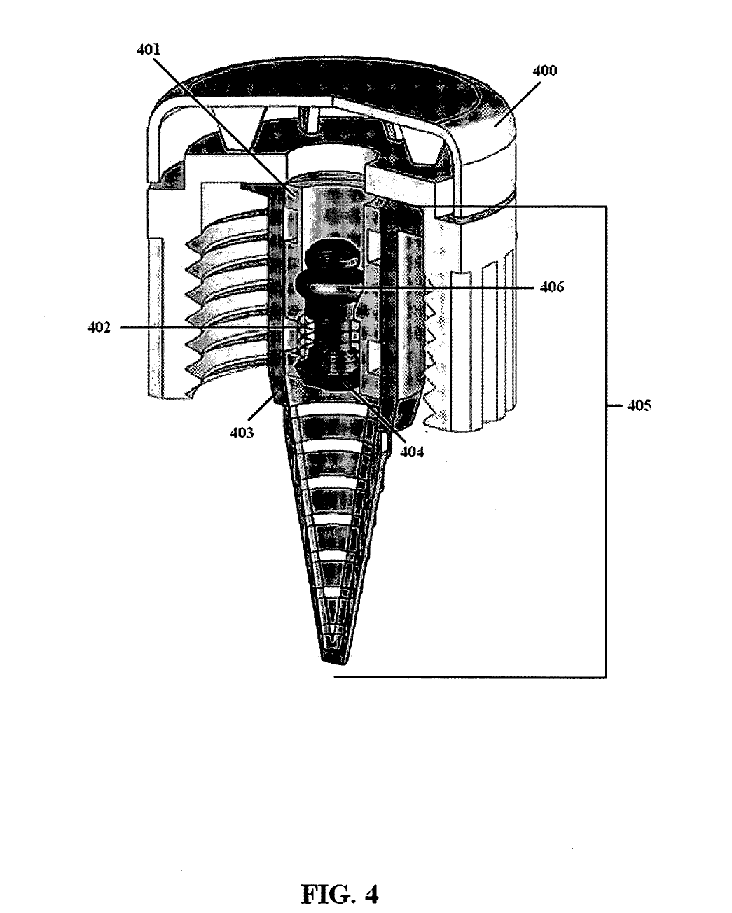

FIG. 4 is an illustration depicting an internal view of a check-valve equipped emitter used to prevent low head drainage, in accordance with an exemplary embodiment of the present invention.

Emitter 400 has been equipped with a sealing apparatus 405 which comprises of a valve housing 401, a spring 402, a screen 403, a plunger 404, and an o-ring 406. Typically, valve housing 401 and screen 403 are separate components, but they may be combined together in a way that constitutes one single housing or body, without departing from the scope of the present invention.

Typically, emitter 400 is a pre-manufactured emitter commonly found in the field. Nevertheless, emitter 400 may be specially made with unique specifications. However, it is desirable to utilize a sealing apparatus that is easily adoptable and fits standard parts in any irrigation system in order to make replacement and use easier for consumers.

Valve housing 401, screen 403, and plunger 404 may be constructed of any type of material known in the art that is suitable for irrigation purposes and capable of sustaining the stress related with exposure to flowing water.

In an exemplary embodiment, valve housing 401, screen 403, and plunger 404 are manufactured using injection molding to make each part using thermoplastic materials, which may be desirable since this technique is cost effective and thermoplastic materials are fairly inexpensive.

O-ring 406 may be a loop constructed of an elastomer with a round (o-shaped) cross-section to be utilized as a seal for sealing apparatus 405. O-ring 406 may be designed to be seated in a groove and compressed during assembly between two or more parts, creating a seal at the interface.

Sealing apparatus 405 is shown here constructed of six components including screen 403. However, sealing apparatus 405 may be implemented with a variety of products so as to make one single unit, or may be a separate unit that may fit within other products such as emitter 400. In one embodiment, sealing apparatus 405 may be implemented with emitter 400 so as to unify both bodies into one, wherein sealing apparatus 405 and emitter 400 are one single apparatus.

Sealing apparatus 405 may use a variety of criteria known in the art in determining its open and closed positions to allow fluid flow. In one embodiment, the criteria is a threshold pressure, in another embodiment, the criteria is an electronic input, and in another embodiment, the criteria is a manual input.

Sealing apparatus 405 may take a variety of forms without departing from the scope of the present invention. For example, sealing apparatus 405 can be any type of valve such as a ball check-valve, a swing check valve, a clapper valve, a stop-check valve, a lift-check valve, an electronic valve or any other type of valve that can control the flow of a fluid from irrigating pipes to outlet nozzles.

In an exemplary embodiment sealing apparatus 405 is implemented with screen 403 as a single unit so as to provide easy installation with various types of nozzles.

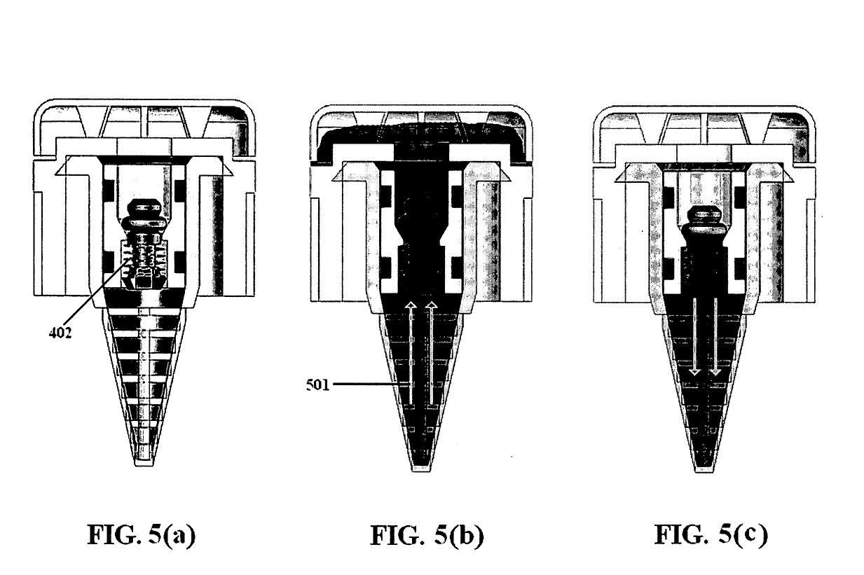

Now turning to FIG. 5(a)-FIG. 5(c) emitter 400 is illustrated in three distinct stages of operation, in accordance with an exemplary embodiment of the present invention, wherein emitter 400 has been equipped with screen 403 and sealing apparatus 405.

FIG. 5(a) depicts emitter 400 in its closed position before any water has been introduced to an irrigation system. Spring 402 is in its expanded position thus keeping sealing apparatus 405 sealed.

FIG. 5(b) depicts emitter 400 once water has been turned on and has traveled through the pipelines of an irrigation system for emitter 400 to irrigate a targeted soil. Fluid pressure 501 pushes upward sealing apparatus 405 causing spring 402 to compress therefore opening sealing apparatus 405. As fluid passes through sealing apparatus 405's channel, fluid reaches the emitter 400's outlets and is dispensed.

FIG. 5(c) depicts emitter 400 at the end or termination of an irrigation cycle. An irrigation system has stopped pumping water therefore decreasing fluid pressure 501. The force of the spring naturally brings sealing apparatus 405 to a close position, thus not allowing any water to flow through sealing apparatus 405's channel up to the openings on emitter 400.

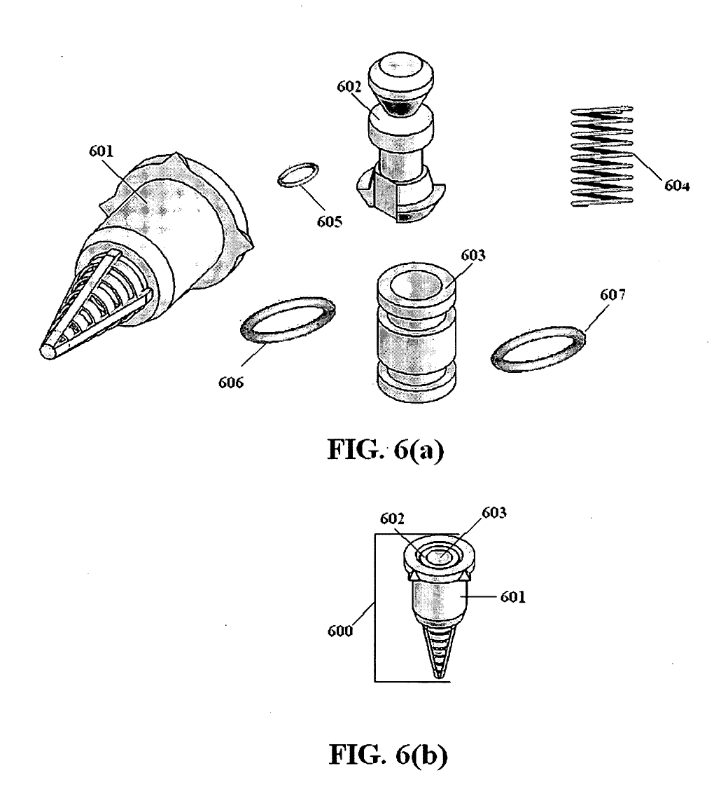

FIG. 6(a) and FIG. 6(b) are illustrations depicting the components of a screen outfitted with a check-valve to prevent low head drainage upon a decrease of fluid pressure within an irrigation system, according to an exemplary embodiment of the present invention.

Sealing apparatus 600 comprises of screen 601, plunger 602, valve body 603, inner o-ring 605, outer o-rings 606 and 607, and spring 604. The various parts may be manufactured using any type of material known in the art that is suitable for irrigation purposes and capable of sustaining the stress related with exposure to flowing fluid.

As discussed above, in an exemplary embodiment, valve body 603, screen 601, and plunger 602 are manufactured using injection molding to make each part using thermoplastic materials, which may be desirable since this technique is cost effective and thermoplastic materials are fairly inexpensive.

Spring 604 determines the threshold pressure. The threshold pressure is the amount of pressure necessary to open sealing apparatus 600 and can be made of a variety of materials including plastics and metals. Alternatively, spring 604 may be rubber, silicon, a sponge, or any other biasing device capable of returning to its original shape without departing from the scope of the present invention. In an exemplary embodiment, spring 604 can withstand up to 4 PSI of fluid pressure before allowing fluid to pass through sealing apparatus 600. Naturally, different irrigation systems have different irrigation requirements and specifications, thus spring 604's capacities may vary without departing from the scope of the present invention.

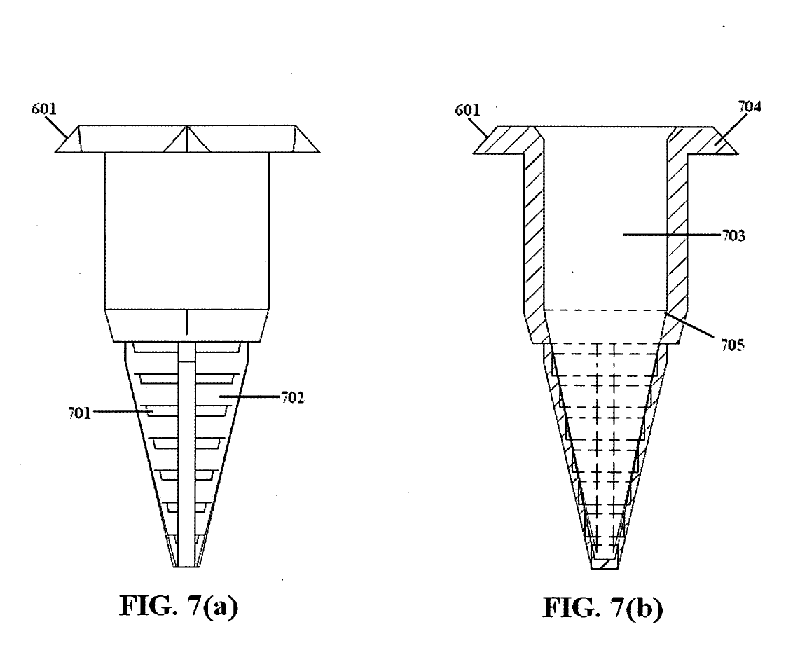

FIG. 7(a) and FIG. 7(b) offer an external and cross sectional view of one component of sealing apparatus 600, in accordance with an exemplary embodiment of the present invention.

FIG. 7(a) is an external view of screen 601 with screen openings 701 to allow the free flow of fluid when in use, and pane 702 to prevent debris or other particles from clogging a nozzle, for example an emitter or sprinkler.

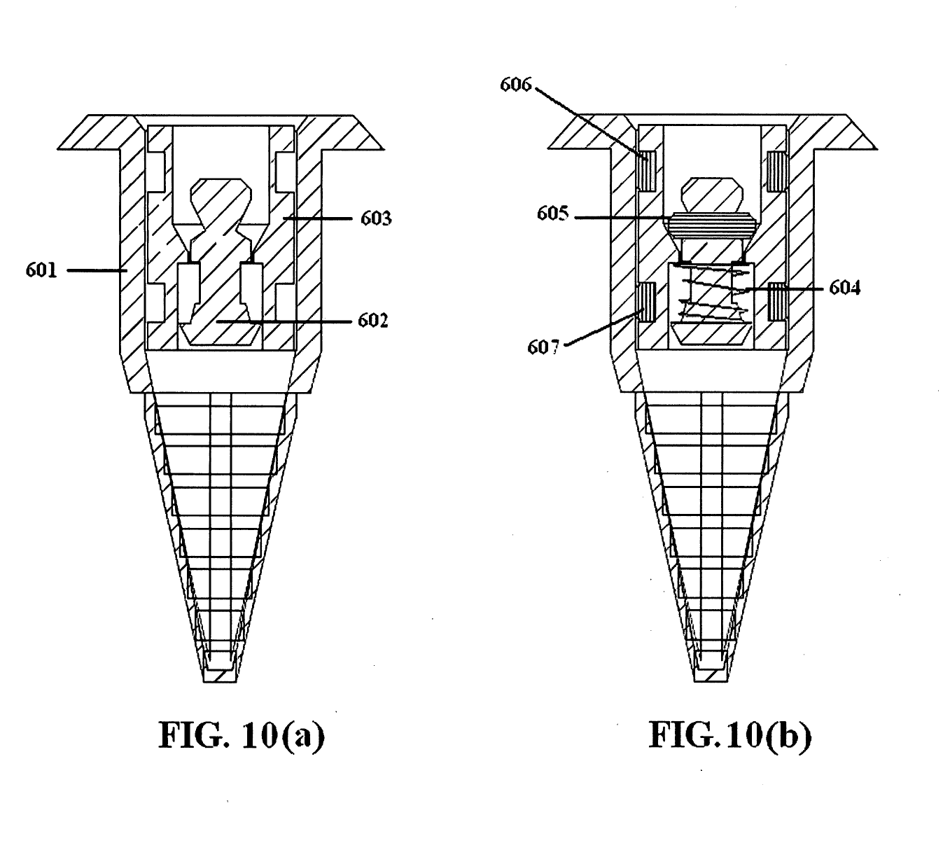

FIG. 7(b) is a cross-sectional view of screen 601 depicting outer wall 704, inner cavity 703 and angled interior wall 705. Outer wall 704 houses valve body 603 which rests on interior wall 705 (see FIG. 9(a)-(b) and FIG. 10(a)-(b)). Interior wall 705 is angled so as to secure body 603 in place.

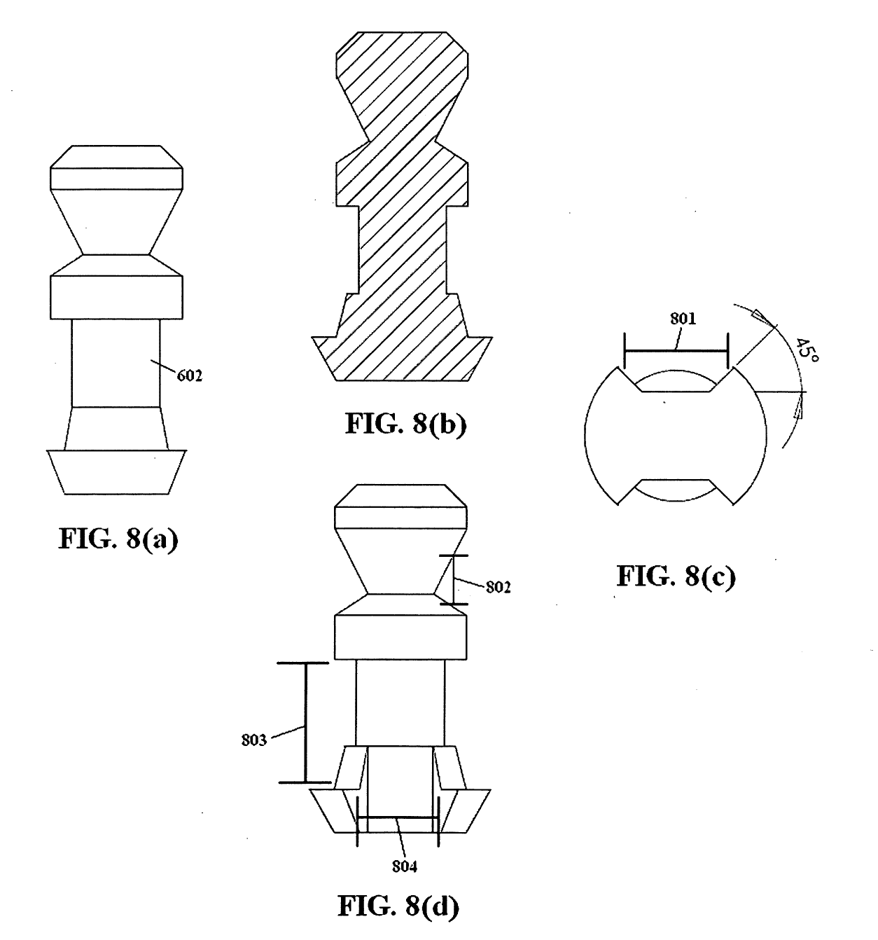

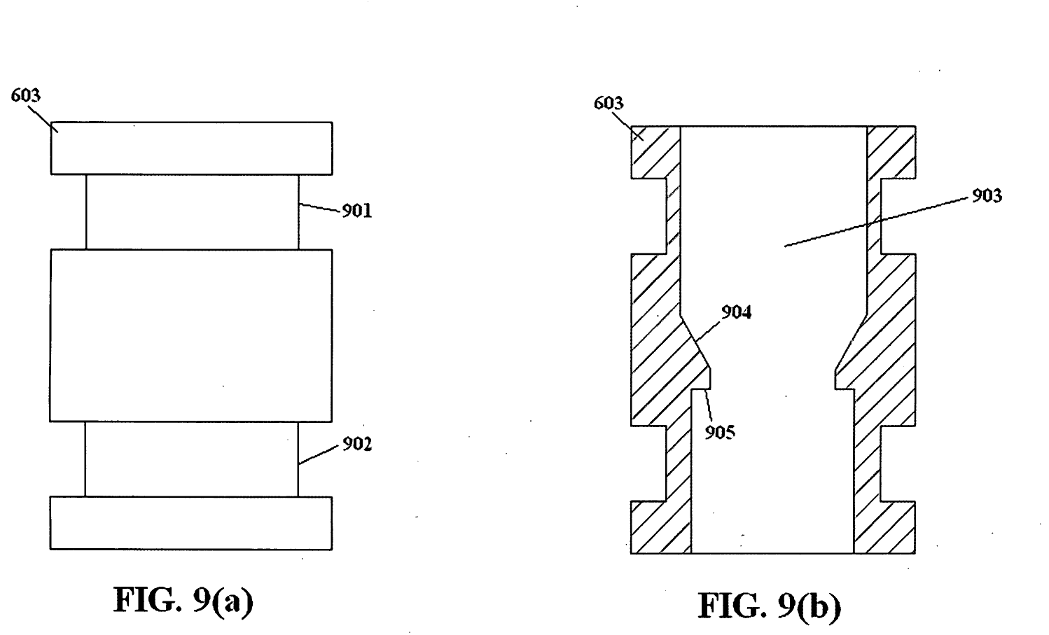

FIG. 8(a)-FIG. 8(d) are different views of a plunger fitted in accordance with an exemplary embodiment of the present invention.

FIG. 8(a) is a side view of plunger 602. FIG. 8(b) is a cross-sectional view of plunger 602 which is constructed of the same materials as the rest of sealing apparatus 600 and is solid without any cavities or openings, but comprises of a shape suitable to hold inner o-ring 605. FIG. 8(c) is a bottom view of plunger 602 depicting openings 801 that increase the area for fluid flow when plunger 602 is compressed by spring 604 into sealing apparatus 600's open position. FIG. 8(d) is a side view of plunger 602 depicting side wall 803 designed to hold spring 604 in place.

FIG. 9(a) and FIG. 9(b) are different views of yet another component of sealing apparatus 600, in accordance with an exemplary embodiment of the present invention.

FIG. 9(a) is a side view of valve body 603 depicting grooves 901 and 902 designed to hold in place outer o-rings 606 and 607; FIG. 9(b) is a cross-sectional view of valve body 603 revealing channel 903 which holds plunger 602 and spring 604 in place. Additionally, channel 903 is the area for fluid flow to pass through sealing apparatus 600. Inner wall 904 is angled so as to provide proper contact with o-ring 605 when plunger 602 is on a closed position, thus sealing apparatus 600. Ledge 905 and ledge 803 on plunger 602, house spring 604 inside valve body 603.

Finally, FIG. 10(a) and FIG. 10(b) shows 2 additional cross-sectional views of screen 601, plunger 602, valve body 603, spring 604, inner o-ring 605, and outer o-rings 606 and 607 assembled into sealing apparatus 600 in accordance with an exemplary embodiment of the present invention.

A system and method for water-conserving irrigation utilizing check-valve equipped emitters has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. An apparatus for conserving water in an irrigation system comprising:
a filtering device adapted to connect to a connector of an irrigation outlet nozzle of said irrigation system, and
a valve within said filtering device to prevent a flow of fluid out of said connector when a fluid pressure into said valve is less than a threshold pressure.

2. The apparatus of claim 1, wherein said valve further comprises:
a biasing device connected to said filtering device that determines said threshold pressure, and
a sealing device connected to said biasing device that creates a seal at said connector when said fluid pressure into said valve is less than said threshold pressure.

3. The apparatus of claim 2, wherein said fluid pressure into said valve relates to an operating pressure generated by the operation of said irrigation system.

4. The apparatus of claim 3, wherein said biasing device comprises a spring that decompresses when said fluid pressure into said valve is insufficient to compress said spring.

5. The apparatus of claim 4, wherein said sealing device further comprises:
a plunger connected to said spring that shifts with the decompression of said spring, and
an o-ring wrapped around said plunger creating said seal.

6. The apparatus of claim 5, wherein said apparatus is used in connection with a low volume irrigation outlet nozzle.

7. The apparatus of claim 6, wherein said filtering device is a screen.

8. The apparatus of claim 7, wherein said low volume irrigation outlet nozzle is an emitter.

9. An apparatus for conserving water in an irrigation system comprising:
a low volume irrigation outlet nozzle, and
a valve within said low volume irrigation outlet nozzle to prevent a flow of fluid out of said low volume irrigation outlet nozzle when a fluid pressure into said valve is less than a threshold pressure.

10. The apparatus of claim 9, wherein said low volume irrigation outlet nozzle is an emitter.

11. The apparatus of claim 10, wherein said valve further comprises:
a biasing device connected to said low volume irrigation outlet nozzle that determines said threshold pressure, and
a sealing device connected to said biasing device that creates a seal at said low volume irrigation outlet nozzle when said fluid pressure into said valve is less than said threshold pressure.

12. The apparatus of claim 11, wherein said fluid pressure into said valve relates to an operating pressure generated by the operation of said irrigation system.

13. The apparatus of claim 12, wherein said biasing device comprises a spring that decompresses when said fluid pressure into said valve is insufficient to compress said spring.

14. The apparatus of claim 13, wherein said sealing device further comprises:
a plunger connected to said spring that shifts with the decompression of said spring, and
an o-ring wrapped around said plunger creating said seal.

15. The apparatus of claim 14, further comprising a filtering device connected to said low volume irrigation outlet nozzle.

16. An irrigation system for conserving water comprising:
an irrigation fluid source,
a plurality of irrigation outlet nozzles, and
irrigation pipes to route a fluid from said irrigation fluid source to said plurality of irrigation outlet nozzles;
wherein each irrigation outlet nozzle comprises:
a filtering device adapted to connect to a connector of each irrigation outlet nozzle of said irrigation system, and
a valve within said filtering device to prevent a flow of fluid out of said connector when a fluid pressure into said valve is less than a threshold pressure.

17. The irrigation system of claim 16, wherein said apparatus is used in connection with a low volume irrigation outlet nozzle.

18. The irrigation system of claim 17, wherein said low volume irrigation outlet nozzle is an emitter.

19. The irrigation system of claim 16, wherein said valve further comprises:
a biasing device connected to said filtering device that determines said threshold pressure, and
a sealing device connected to said biasing device that creates a seal at said connector when said fluid pressure into said valve is less than said threshold pressure.

20. The irrigation system of claim 19, wherein said fluid pressure into said valve relates to an operating pressure generated by the operation of said irrigation system.

21. The irrigation system of claim 20, wherein said biasing device comprises a spring that decompresses when said fluid pressure into said valve is insufficient to compress said spring.

22. The irrigation system of claim 21, wherein said sealing device further comprises:
a plunger connected to said spring that shifts with the decompression of said spring, and
an o-ring wrapped around said plunger creating said seal.

23. The irrigation system of claim 22, wherein said apparatus is used in connection with a low volume irrigation outlet nozzle.

24. The irrigation system of claim 23, wherein said filtering device is a screen.

25. The irrigation system of claim 24, wherein said low volume irrigation outlet nozzle is an emitter.

26. A method of conserving water in an irrigation system comprising:
installing a valve into a filtering device,
connecting said filtering device to a connector of said irrigation system,
turning on a fluid pressure to allow a fluid to flow to said irrigation system,
turning off said fluid pressure, and
preventing a flow of fluid out of said connector when said fluid pressure into said valve is less than a threshold pressure using said valve.

27. The method of claim 26, wherein prevention of said flow of fluid further comprises:
determining said threshold pressure using a biasing device connected to said filtering device, and
sealing said connector when said fluid pressure into said valve is less than said threshold pressure using a sealing device that is connected to said biasing device.

28. The method of claim 27, wherein said fluid pressure into said valve relates to an operating pressure generated by the operation of said irrigation system.

29. The method of claim 28, wherein determining said threshold pressure is achieved by decompressing a spring when said fluid pressure into said valve is insufficient to compress said spring.

30. The method of claim 29, wherein sealing said connector further comprises:
wrapping an o-ring around a plunger connected to said spring, and
shifting said plunger with the decompression of said spring.

31. The method of claim 30, further comprising:
connecting said filtering device to a low volume irrigation outlet nozzle.

32. The method of claim 31, wherein said filtering device is a screen.

33. The method of claim 32, wherein said low volume irrigation outlet nozzle is an emitter.

34. A method of conserving water in an irrigation system comprising:
installing a valve to a low volume irrigation outlet nozzle,
turning on a fluid pressure to allow a fluid to flow to an irrigation system,
turning off said fluid pressure, and
preventing a flow of fluid out of said low volume irrigation outlet nozzle when said fluid pressure into said valve is less than a threshold pressure using said valve.

35. The method of claim 34, wherein said low volume irrigation outlet nozzle is an emitter.

36. The method of claim 35, wherein prevention of said flow of fluid further comprises:
determining said threshold pressure using a biasing device connected to said low volume irrigation outlet nozzle, and
sealing said low volume irrigation outlet nozzle when said fluid pressure into said valve is less than said threshold pressure using a sealing device that is connected to said biasing device.

37. The method of claim 36, wherein said fluid pressure into said valve relates to an operating pressure generated by the operation of said irrigation system.

38. The method of claim 37, wherein determining said threshold pressure is achieved by decompressing a spring when said fluid pressure into said valve is insufficient to compress said spring.

39. The method of claim 38, wherein sealing said connector further comprises:
wrapping an o-ring around a plunger connected to said spring, and
shifting said plunger with the decompression of said spring.
